(19) United States
(12) Patent Application Publication
(10) Pub. No.: US 2023/0356984 A1
(43) Pub. Date: Nov. 9, 2023

(54) GRIPPER

(71) Applicant: Ocado Innovation Limited, Hatfield, Hertfordshire (GB)

(72) Inventors: Wilhelm JOHANNISSON, Hatfield, Hertfordshire (GB); Andrew INGRAM-TEDD, Hatfield, Hertfordshire (GB); Lars Sverker Ture LINDBO, Hatfield, Hertfordshire (GB); Xuan SUN, Hatfield, Hertfordshire (GB); Paul TURNER, Hatfield, Hertfordshire (GB)

(73) Assignee: Ocado Innovation Limited, Hatfield, Hertfordshire (GB)

(21) Appl. No.: 18/040,333

(22) PCT Filed: Aug. 2, 2021
(86) PCT No.: PCT/EP2021/071584

§ 371 Date: Feb. 2, 2023

(30) Foreign Application Priority Data
Aug. 3, 2020 (GB) 2012042.4
Apr. 28, 2021 (GB) 2106062.9

(51) Int. Cl. B66C 1/66; B65G 1/04; B66C 13/46; B66C 19/00

(52) U.S. Cl. CPC B66C 1/663; B65G 1/0464; B66C 13/46; B66C 19/00

(57) ABSTRACT

A gripper for latching to a storage container is disclosed which includes: a gripper housing; a pair of gripper arms held in the gripper housing, wherein the gripper arms have cooperating shapes; and a movable rotatable actuator held in a channel between the pair of gripper arms for moving the gripper arms between closed and open positions. A load handling device for lifting and moving storage containers can include one or more grippers. A method of using a gripper, and a grid-based storage and retrieval system which can include at least one load handling device containing one or more grippers are also disclosed.

The present invention relates to a gripper for latching to an object. More specifically the present invention relates to gripper devices which may move between open and closed positions to secure the gripper within an opening on the object. One or more grippers may be used as part of a lifting assembly of a load handling device, operating on storage systems, the storage systems having storage bins in stacks.

### BACKGROUND

Methods of handling containers stacked in rows have been well known for decades. Some such systems, for example as described in U.S. Pat. No. 2,701,065, to Bertel, comprise free-standing stacks of containers arranged in rows in order to reduce the storage volume associated with storing such containers but yet still provide access to a specific container if required. Access to a given container is made possible by providing relatively complicated hoisting mechanisms which can be used to stack and remove given containers from stacks. The costs of such systems are, however, impractical in many situations and they have mainly been commercialised for the storage and handling of large shipping containers.

The concept of using free-standing stacks of containers and providing a mechanism to retrieve and store specific containers has been developed further, for example as described in EP 0767113 B to Cimcorp. EP '113 discloses a mechanism for removing a plurality of stacked containers, using a robotic load handler in the form of a rectangular tube which is lowered around the stack of containers, and which is configured to be able to grip a container at any level in the stack. In this way, several containers can be lifted at once from a stack. The movable tube can be used to move several containers from the top of one stack to the top of another stack, or to move containers from a stack to an external location and vice versa. Such systems can be particularly useful where all of the containers in a single stack contain the same product (known as a single-product stack).

In the system described in EP '113, the height of the tube has to be at least as high as the height of the largest stack of containers, so that that the highest stack of containers can be extracted in a single operation. Accordingly, when used in an enclosed space such as a warehouse, the maximum height of the stacks is restricted by the need to accommodate the tube of the load handler.

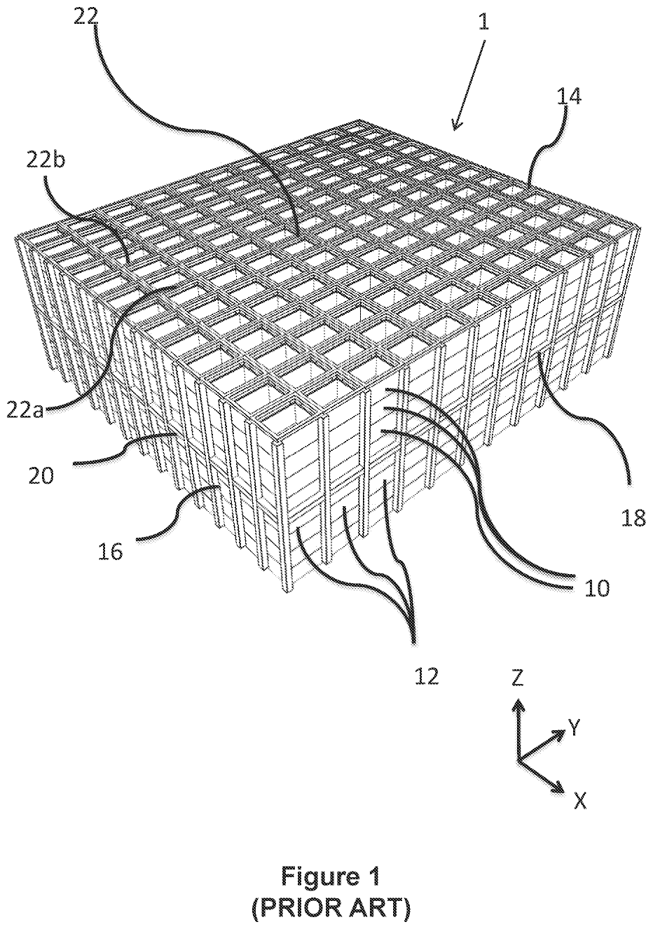

EP 1037828 B1 (Autostore) describes a system in which stacks of containers are arranged within a frame structure. A system of this type is illustrated schematically in FIGS. 1 to 4 of the accompanying drawings. Robotic load handling devices can be controllably moved around the stack on a system of tracks on the uppermost surface of the stack.

A load handling device is described in UK Patent Application No. GB2520104A—Ocado Innovation Limited—where each robotic load handler only covers one grid space, thus allowing high density of load handlers and thus high throughput of a given size system.

In the known robotic picking systems described above, robotic load handling devices are controllably moved around the top of the stacks on a track system forming a grid. A given load handling device lifts a bin from the stack, the container being lifted containing inventory items needed to fulfil a customer order. The container is carried to a pick station where the required inventory item may be manually removed from the bin and placed in a delivery container, the delivery container forming part of the customer order, and being manually filled for dispatch at the appropriate time. At the pick station, the items may also be picked by industrial robots, suitable for such work, for example as described in UK Patent Application No GB25243838—Ocado Innovation Limited.

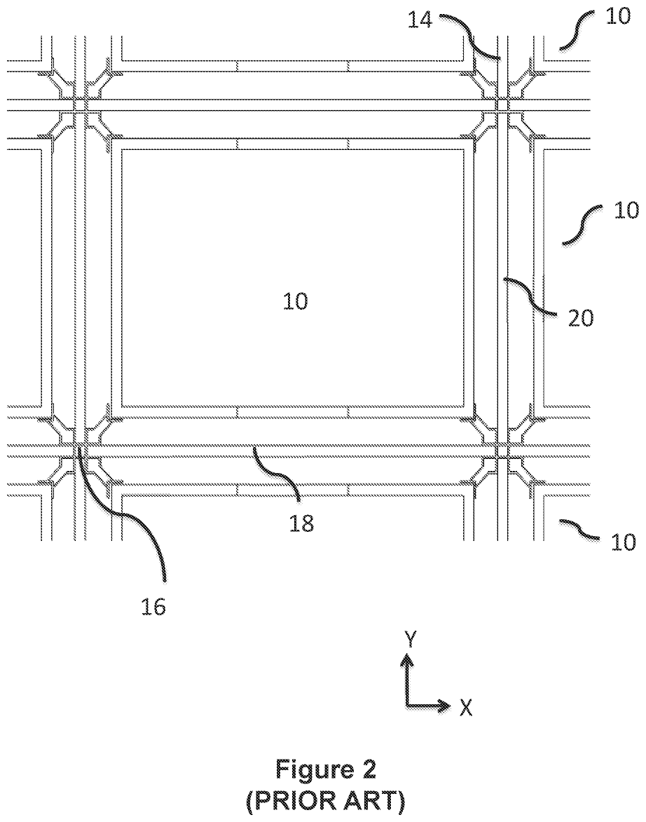

As shown in FIGS. 1 and 2, stackable storage containers, known as bins 10, are stacked on top of one another to form stacks 12. The stacks 12 are arranged in a framework 14 in a warehousing or manufacturing environment. FIG. 1 is a schematic perspective view of the framework 14, and FIG. 2 is a top-down view showing a single stack 12 of bins 10 arranged within the framework 14. Each bin 10 typically holds a plurality of product or inventory items, and the inventory items within a bin 10 may be identical, or may be of different product types depending on the application. Furthermore, the bins 10 may be physically subdivided to accommodate a plurality of different inventory items.

The framework 14 comprises a plurality of upright members 16 that support horizontal members 18, 20. A first set of parallel horizontal members 18 is arranged perpendicularly to a second set of parallel horizontal members 20 to form a plurality of horizontal grid structures supported by the upright members 16. The members 16, 18, 20 are typically manufactured from metal. The bins 10 are stacked between the members 16, 18, 20 of the framework 14, so that the framework 14 guards against horizontal movement of the stacks 12 of bins 10, and guides vertical movement of the bins 10.

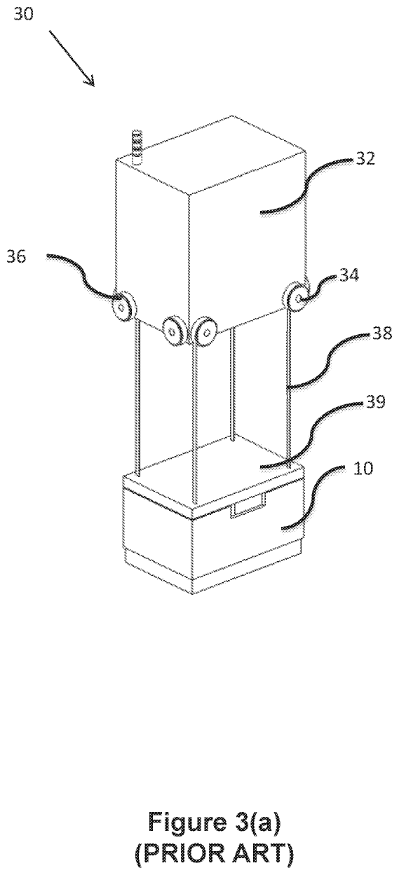

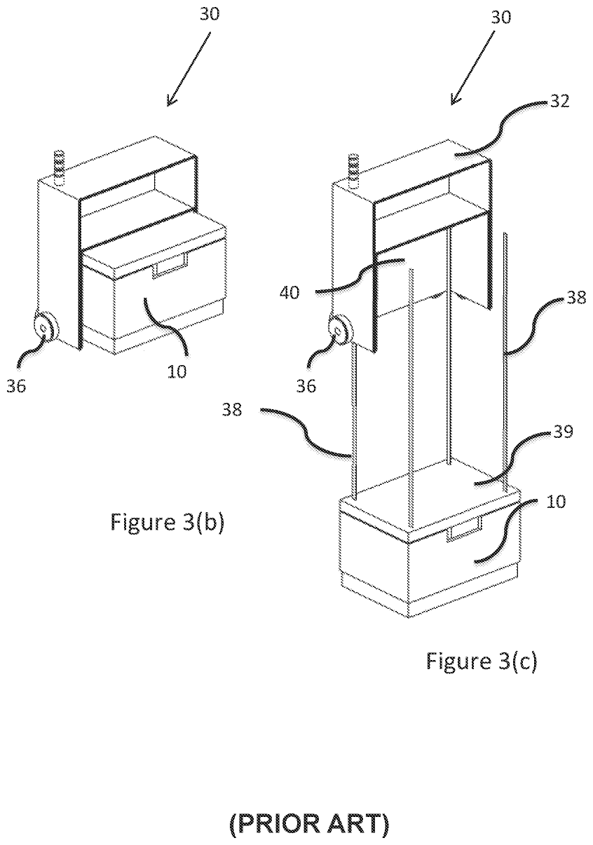

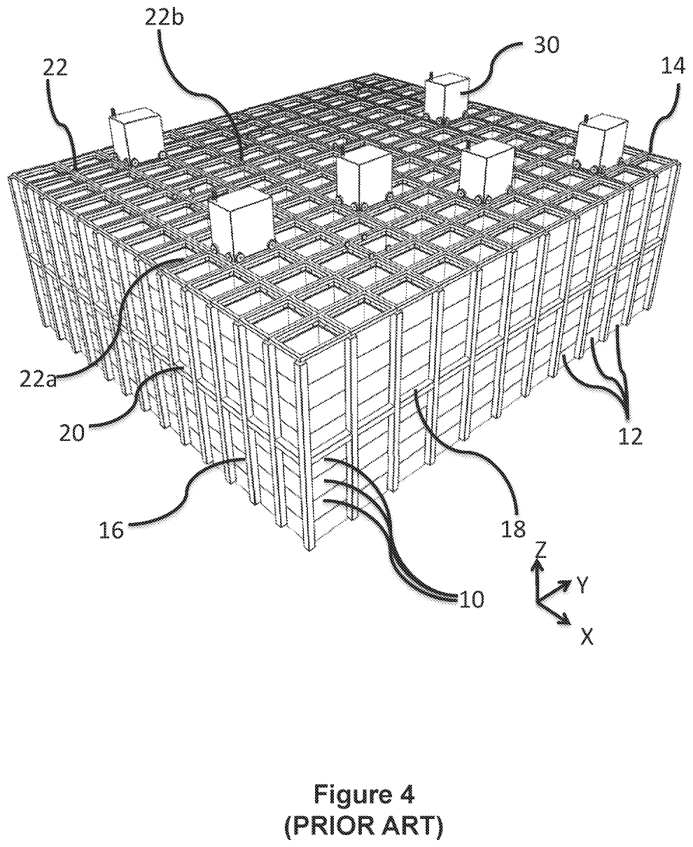

The top level of the framework 14 includes rails 22 arranged in a grid pattern across the top of the stacks 12. Referring additionally to FIGS. 3 and 4, the rails 22 support a plurality of robotic load handling devices 30. A first set 22a of parallel rails 22 guide movement of the load handling devices 30 in a first direction (X) across the top of the framework 14, and a second set 22b of parallel rails 22, arranged perpendicular to the first set 22a, guide movement of the load handling devices 30 in a second direction (Y), perpendicular to the first direction. In this way, the rails 22 allow movement of the load handling devices 30 in two dimensions in the X-Y plane, so that a load handling device 30 can be moved into position above any of the stacks 12.

Each load handling device 30 comprises a vehicle 32 which is arranged to travel in the X and Y directions on the rails 22 of the framework 14, above the stacks 12. A first set of wheels 34, consisting of a pair of wheels 34 on the front of the vehicle 32 and a pair of wheels 34 on the back of the vehicle 32, are arranged to engage with two adjacent rails of the first set 22a of rails 22. Similarly, a second set of wheels 36, consisting of a pair of wheels 36 on each side of the vehicle 32, are arranged to engage with two adjacent rails of the second set 22b of rails 22. Each set of wheels 34, 36 can be lifted and lowered, so that either the first set of wheels 34 or the second set of wheels 36 is engaged with the respective set of rails 22a, 22b at any one time.

When the first set of wheels 34 is engaged with the first set of rails 22a and the second set of wheels 36 are lifted clear from the rails 22, the wheels 34 can be driven, by way of a drive mechanism (not shown) housed in the vehicle 32, to move the load handling device 30 in the X direction. To move the load handling device 30 in the Y direction, the first set of wheels 34 are lifted clear of the rails 22, and the second set of wheels 36 are lowered into engagement with the second set of rails 22a. The drive mechanism can then be used to drive the second set of wheels 36 to achieve movement in the Y direction.

In this way, one or more robotic load handling devices 30 can move around the top surface of the stacks 12 on the framework 14, as shown in FIG. 4 under the control of a centralised control utility (not shown). Each robotic load handling device 30 is provided with lifting means 38 for lifting one or more bins 10 from the stack 12 to access the required products.

The body of the vehicle 32 comprises a cavity 40, the cavity 40 being of a size capable of holding a bin 10. The lifting means 38 comprises winch means and a bin gripper assembly 39. The lifting means lifts a bin 10 from the stack 12 to within the cavity 40 within the body of the vehicle 32. When in the cavity 40, the bin 10 is lifted clear of the rails beneath, so that the load handling device can move laterally to a different location on the grid. On reaching the target location, for example another stack, an access point in the storage system or a conveyor belt, the bin 10 can be lowered from the cavity and released from the gripper assembly 39.

In this way, multiple products can be accessed from multiple locations in the grid and stacks at any one time.

The above description describes a storage system in connection with, for example, groceries. FIG. 4 shows a typical such storage system, the system having a plurality of load handling devices 30 active on the grid above the stacks 12.

FIGS. 1 and 4 show the bins 10 in stacks 12 within the storage system. It will be appreciated that there may be a large number of bins 10 in any given storage system and that many different items may be stored in the bins 10 in the stacks 12. Each bin 10 may contain different categories of inventory items within a single stack 12.

In one system described above and further in UK Patent Application Number GB2517264A—Ocado Innovation Limited, hereby incorporated by reference—the storage system comprises a series of bins 10 that may further comprise delivery containers DT with customer orders contained therein or may further comprise bins 10 with inventory items awaiting picking contained therein. These different bins 10 and combinations thereof may be contained in the storage system and be accessed by the robotic load handling devices 30 as described above.

It will be appreciated that automated or semi-automated storage and retrieval systems are not limited to systems directed to groceries. For example, the technology can be applied to shipping, baggage handling, vehicle parking, indoor or hydroponic greenhouses and farming, modular buildings, self-storage facilities, cargo handling, transport switchyards, manufacturing facilities, pallet handling, parcel sortation, airport logistics (ULD) and general logistics to name but a few possible applications. It will be appreciated that storage and retrieval systems of different types will have different technical requirements.

It is against this background that the present invention has been devised.

### SUMMARY OF THE INVENTION

Aspects of the invention are set out in the accompanying claims.

One aim of the present invention is to provide an improved gripper for use as part of a lifting assembly on a load handling device. In some aspects, the gripper may be ‘self-actuating’ or passive by virtue of being connected to other actions, such as lowering the gripper into position. In this way, the gripper does not need other devices nor additional parts to be actuated. For example, some prior art devices require a solenoid to open and close the grippers. It will be appreciated that such a system would require additional power and data to operate. In contrast, the gripper herein, is simply lowered into position and the lowering action may cause the gripper to actuate, moving between open and closed positions, and could have no electrical components at all.

It will be appreciated that the gripper may be used on other types of device where a latching mechanism is required.

A gripper for latching to a storage container, is provided. The gripper comprises: a gripper housing; a pair of gripper arms held in the gripper housing, wherein the gripper arms have cooperating shape; and a movable rotatable actuator means held in a channel between the pair of gripper arms for moving the gripper arms between closed and open positions, wherein the gripper is actuated with substantially vertical or z-axis movement of the actuator means.

The arms of the gripper have a cooperating shape so that they fit together. For example, where one arm of the pair has a cavity or recess, the other arm of the pair has a corresponding protrusion. Thus, the shape of the arms mutually cooperate to fit together with overlapping or interlocking forms. In some cases, the pair of gripper arms may be a substantially mirrored pair.

The pair of gripper arms are held in position by the gripper housing. Each of the arms may be pivotally attached to the gripper housing, and the edges of the housing may be shaped to accommodate of the distal end of the arms, distal to the pivot attachment point or head. In this way, the pair gripper arms are movable between a first (closed) position and a second (open) position.

Movement of the gripper between open and closed positions may be controllable with an actuator means. At the head end of the gripper arms, which is held by the gripper housing, the gripper arms are shaped to provide an opening and a substantially straight channel therebetween which holds the actuator means in place. Below or beyond the head end of the gripper arms, the channel continues into other cavities or recesses between the shaped gripper arm pair.

An inner surface of each of the gripper arms may comprise a cam surface having a number of grooves or channels for receiving a distal end of the actuator means. Alternatively, the surface may be considered to be a shaped substantially internal guide, shaped substantially internal channel or shaped substantially internal channel guide. The cam surface may be at least partially curved or spiralled. Each of the channels spiral in the same rotational direction. The pair of gripper arms may comprise four substantially enclosed channels for receiving the distal end of the actuator means.

The inner surface of each of the gripper arms may be considered to be the surface which comes together with the respective surface of the cooperating pair. It will be appreciated that, due to the cooperating shape of the gripper arms, the surface will not be flat. In addition to the overlapping or interlocking forms of the cooperating surface which allow the pair of gripper arms to be held together in closed position, grooves or channels may be formed on the mating surface. In this way, the distal end of the actuator means can be moved through a network of pathways, within the cavity between the pair of gripper arms, formed by the grooves or channels and guided by the sides of the channels or grooves.

The curved or spiral shape of the pathways may introduce an angular rotation to the actuator means, as the distal end of the actuator means moves along the pathways. The pathway may be substantially ribbon shaped. The amount or rate of curve along each pathway may be substantially constant, or the pathway may go through discontinuities of curvature, for example at points where the actuation direction changes from up to down or down to up.

By rotating always in the same direction, the movement of the actuator through the channels may be smoother and without interruption with direction changes.

The channels may be shaped to direct the actuator means along distinct routes through the network of pathways. Particular pathways or channels may cause particular distinct resulting movements of the gripper.

The internal or substantially enclosed channels may be interlinked. In this way, the actuator means may move from one channel to the next in sequence. Where each of the internal channels spiral in the same rotational direction, the actuator means may rotate with each movement, continuously in the same direction, from one channel to the next.

In an alternative arrangement, the channels may be crossed shaped, or have crossing paths.

A first actuation movement may cause the gripper arms to move from the closed position to the open position, a second actuation movement locks the gripper arms in the open position, a third actuation movement unlocks the gripper arms, AND OR a fourth actuation movement causes the gripper arms to move from the open position to the closed position.

For example, movement through one channel may cause the gripper to open or close. Movement through another or next channel may cause the gripper to lock in position. In this way, the gripper may be controlled through mechanical means. Some channels may be similar to other channels but having rotational symmetry to allow a continuous sequence between the network of channels which comes around to the beginning again.

Each of the pair of gripper arms may be substantially the same.

Where the pair of gripper arms are similar, the number of different parts that make up the gripper is simplified. If the gripper arms are made injection moulding, for example, only one mould would be necessary. In this way, the gripper is simplified, capital costs may be reduced, and maintenance may be simplified. It will be appreciated that the gripper arms could be used interchangeably, and it would not be necessary to ensure use of the correct parts as a pair as they are the same.

Each of the pair of gripper arms have 180° rotational symmetry about a z-axis.

Ensuring that the gripper arms have a cooperating shape of projections and recesses may be achieved with rotational symmetry. In this way, it is not necessary to have left-handed/right-handed pair of gripper arms to fit together. The rotational symmetry may be about a z-axis or a substantially vertical axis extending along the main axis of the gripper arms, from the head of the gripper arms to the distal end.

The gripper may further comprise indicating means for rotational position of the actuator means.

For example, the means for indicating rotational position may be an orientation mark on the upper surface of the plunger. In this way, a reader may be used to determine the position of the gripper arms (open, closed and or locked) based on the actuator orientation, even if the gripper arms are not visible. The orientation mark may be a reflective surface which is readily visible to a vision sensor from a distance.

The indicating means may include an indicating plate and a cover plate disposed over the indicating plate. The indicating plate may include at least one differentiating region on its top surface, i.e. a region that is distinguishable from a top surface of the cover plate. For example, the differentiating region may be a coloured region or a textured region that is different to the colour or texture of the top surface of the cover plate. The indicating plate may be elongate and may include a differentiating region at each longitudinal end of the indicating plate.

The cover plate may include at least one cut-out that matches the shape of the differentiating region(s) on the indicating plate such that when the cut-out(s) is/are aligned with the differentiating region(s), the differentiating region(s) may be detectable or visible from above. The indicating means may also include an indicator attachment where the cover plate and the indicating plate may fit onto the indicator attachment. The indicator attachment may include a bolt head (e.g. a central bolt head) which passes through a locating hole (e.g. a central locating hole) in the indicating plate thereby assembling the indicating plate onto the indicator attachment. The bolt head may further fit into a projection on an underside face of the cover plate and the projection may include a hole or recess for receiving the bolt head. The cover plate may fit onto the bolt head such that rotation of the bolt head may result in synchronised and equal rotation of the cover plate. For example, the bolt head may comprise a semi-circular cross-section and the hole or recess in the projection may comprise a semi-circular cross-section of same size as the cross-section of the bolt head. In this way, rotation of the bolt head may result in synchronised and equal rotation of the cover plate. Thus, the cover plate may rotate with the indicator attachment and relative to the indicating plate.

The indicator attachment may include a ball chain receiving portion for receiving a ball chain. The ball chain receiving portion may include sockets able to receive the balls from the ball chain.

The actuator means may comprise an actuator attachment which may be connected to a top or proximal end of the actuator means. The actuator attachment may be connected to the actuator means such that rotation of the actuator means causes rotation of the actuator attachment, e.g. synchronised and equal rotation of the actuator attachment. The actuator attachment may include a ball chain receiving portion for receiving the ball chain. The ball chain receiving portion may encircle the actuator means, i.e. may surround a longitudinal axis of the actuator means, and may include sockets able to receive the balls from the ball chain. The ball chain may loop around the ball chain receiving portion of the indicator attachment and the ball chain receiving portion of the actuator attachment, thus mechanically connecting the actuator means with the indicating means. The ball chain receiving portions may act as pulleys or sprockets for the ball chain such that as the actuator attachment rotates, the ball chain is driven to rotate the indicating means. The ball chain may ensure synchronised and equal rotation between the actuator means and the indicating means.

As described above, movement of the gripper between open and closed positions may be controllable with the actuator means. In particular, movement of the gripper arms between a closed position, an open position and an open and locked position may be controllable by rotation of the actuator means. As the actuator means rotates to open and close the gripper arms, the indicator attachment may rotate synchronously by an equal amount (due to the action of the ball chain). Rotation of the indicator attachment may rotate the cover plate such that in a first position, the cut-out(s) are not aligned with (i.e. over) the differentiating region(s) on the indicating plate, i.e. the differentiating region(s) are covered by the cover plate. In this way, the differentiating region(s) on the indicating plate may not be detectable or visible e.g. to a reader or sensor. The actuator means may cause rotation of the indicator attachment and position the cover plate in a second position where the one cut-out(s) are aligned with (i.e. are over) the differentiating region(s) (i.e. the differentiating region(s) are exposed by the cut-out(s) of the cover plate) such that the differentiating region(s) are detectable or visible e.g. to a reader or sensor. The first position of the cover plate may correspond to the position of the actuator means when the gripper arms are in the closed position. The second position of the cover plate may correspond to the position of the actuator means when the gripper arms are in the open or open and locked position. In this way, the indicating means with the cover plate in the first position or second position may provide an indication to a reader or sensor of the status of the gripper (i.e. whether the gripper arms are open or closed). The differentiating region(s) may be shaped such that a partial overlap of the cut-out(s) over the differentiating region(s) indicate an intermediary status of the gripper arms, e.g. when the gripper arms are in the open position before they move to the open and locked position (i.e. an open unlocked position).

A lifting assembly may comprise at least one gripper (e.g. four grippers), each gripper comprising an actuator means and an actuator attachment. Each gripper may be provided with an indicating means, i.e. each actuator attachment may be mechanically connected to an indicator attachment of the indicating means e.g. by a ball chain as described above. In this way, a reader or sensor may determine whether the individual grippers of the lifting assembly are in or out of phase with one another, i.e. whether the individual grippers all have their respective gripper arms in the same position (closed or open). The multiple indicating means may be detected simultaneously e.g. by a reader or sensor located at a distance or above the indicating means. The gripper(s) may be located at a periphery or edge of the lifting assembly. The indicating means may be laterally displaced (i.e. laterally displaced relative to the z-axis of the gripper), e.g. the indicating means may be located within the periphery or edge of the lifting assembly. The indicating means may be located towards the centre of the lifting assembly.

The load handling device may include detection means for detecting the status of the indicating means, i.e. whether the differentiating region(s) from the indicating means are visible. Thus, the detection means may detect the status of the indicating means and provide a determination of whether the gripper arms are open or closed. The detection means may include a reader, a sensor, a vision sensor, a camera etc. that can detect from a distance whether the differentiating region(s) are visible, i.e. the detection means may be located at a distance from the indicating means (e.g. above the indicating means). For example, the load handling device may include a camera that can detect whether the differentiating region(s) are visible (i.e. exposed by the cut-out(s)). The detection means may be located on or within the load handling device, e.g. on a bottom of the load handling device. In this way, the detection means may be located above the lifting assembly comprising the gripper(s) and the indicating means. The detection means may detect the status of the indicating means from a distance above the indicating means.

While the foregoing describes an indicating means where the cover plate rotates with the indicator attachment, in other embodiments, the indicating plate may be connected to the indicator attachment such that rotation of the indicator attachment causes rotation of the indicating plate while the cover plate remains fixed.

The indicating means may provide a binary indication of the position of the gripper arms, e.g. ‘open’ or ‘closed’.

In addition or alternatively, a magnet may be located in the upper portion of the plunger. In this way, the orientation of the plunger could be determined using a Hall-sensor. Further, a Hall-sensor may be used to assist in rotation of the plunger to ensure that the plunger is properly orientated.

The gripper may further comprise a detent means for orientating the actuator means.

The detent means may be used to ensure that the actuator means is accurately positioned in the gripper arrangement. It will be appreciated that the detent means may be mechanical or magnetic and is intended to resist or arrest rotation of the actuator means to discrete positions. For example, the detent means may be one or more notches in the head portion of the gripper arms and a cooperating spring loaded ball bearing, or a spring loaded ball bearing in the head portion of the gripper arms and one or more notches in the actuator means. It will be appreciated that a magnetic the detent means may be electrically or electronically controllable. It will be appreciated that the detent means may be releasable. Further it will be appreciated that the detent means may also prove assistance to encourage the actuator means to the next position in sequence.

The gripper may be actuated with substantially vertical or z-axis movement of the actuator means.

The vertical movement of the actuator means may be along the line of the main axis of the gripper arms. To actuate the gripper the actuator is vertically displaced relative to the gripper arms. The actuator may be guided by a frame to ensure that the actuator means remains aligned within the opening and channel between the pair of gripper arms.

Auction movements move the distal end of the actuator up and down within the cavity between the pair of gripper arms. When the actuator is pushed, the distal end moves deeper into the gripper arms, and when the actuator is pulled, the distal end moves towards the top or head of the gripper arms.

The actuator means may comprise a plunger having at least one radial pin located at a distal end for guiding rotational movement of the plunger. The actuator means may comprise a plunger having a pair of radial pins located at a distal end for guiding rotational movement of the plunger. The plunger radial pins may have substantially octagonal cross section. Alternatively, the radial pins may be cross shaped. It will be appreciated that any angled the cross section that may achieve a similar effect is anticipated.

The radial pin(s) may be sized to touch the sides of the internal channels. In this way, the actuator means or plunger is guided through the channels. As the pins move along the sides of the channels as a result of an action of the actuator means, where the channels twist the reaction on the plunger causes the plunger to rotate or twist. The entire plunger may be caused to rotate or twist, or a spinner section of the plunger may rotate or twist. Where the entire plunger is caused to rotate or twist, it may be possible to track and or measure the state of the gripper from above using a vision or sensor system, and or using ML, for example, using the indicator means and or detent means as discussed above.

The pins may have bevelled edges in order to move smoothly through the channels, and stayed aligned with the channels, which may be particularly helpful at discontinuities of curvature.

The channel between the pair of gripper arms may be angled to make a pinch point.

As noted above, the actuator means or plunger is positioned between the pair of gripper arms. A narrowing or pinch point of the channel between the gripper arms at the top or head end of the gripper prevents the plunger pulling out of, or from coming apart from the gripper arms, when the arrangement is held together by the gripper housing. In this way, the plunger is held in place by the pair of gripper arms when the arms are held by the housing. The pinch point may help prevent the plunger from coming loose during assembly or operation and in this way make the gripper more reliable.

Each of the gripper arms may further comprise a number of meshing teeth.

The gripper arms may comprise any number of teeth which fit together with the teeth of the second gripper arm of a pair. The teeth may assist with alignment of the pair of gripper arms relative to each other. Further, the teeth may assist in maintain the gripper in the closed position. The teeth may be located at the lower or distal end of the gripper arms, for example, close to the hook end of the gripper arms.

A distal end of each of the gripper arms may comprise a hook for latching to a storage container, AND OR, the distal end of the gripper arms may be tapered.

It will be appreciated that the gripper may typically be used to latch to another objected. For example, the gripper may be inserted into an opening in a container, and then used to latch to the container. The hook of each of the pair of gripper arms together may be substantially arrow-head shaped, or may be substantially triangular as viewed in the z-x plane. In this way, each tailing side of the arrow-head may engage with the underside of an opening in a container. Further, the point of the arrow-head may assist in guiding the gripper into the opening, as less actuate positioning of the gripper would. In addition, the hook may further be tapered in z-y plane to further assist in guiding the gripper into the opening.

It will be appreciated that the gripper may benefit from being 3D printed, having complex shape. It will be appreciated that the shape of the gripper and other properties or concerns may be optimised using Machine Learning ML techniques.

A load handling device is provided for lifting and moving storage containers (10) stacked in a grid framework (14) structure comprising: a first set of parallel members (22a) and a second set of parallel members (22a) extending substantially perpendicularly to the first set of members (22b) in a substantially horizontal plane to form a grid pattern comprising a plurality of grid spaces, wherein the grid is supported by a set of uprights (16) to form a plurality of vertical storage locations beneath the grid for containers (10) to be stacked between and be guided by the uprights in a vertical direction through the plurality of grid spaces, the load handling device comprising: a body mounted on a first set of wheels being arranged to engage with the first set of parallel members (22a) and a second set of wheels being arranged to engage with the second set of parallel members (22b); and a lifting assembly for raising and or lowering a load, the lifting assembly comprising at least one a gripper as discussed above.

A method of using a gripper is provided, the method comprising the steps of: actuating one or more grippers with a first actuation movement to causes the gripper arms to move from the closed position to the open position,

actuating one or more grippers with a second actuation movement locks the gripper arms in the open position, actuating one or more grippers with a third actuation movement unlocks the gripper arms, AND OR actuating one or more grippers with a fourth actuation movement causes the gripper arms to move from the open position to the closed position.

A grid-based storage and retrieval system is provided, the system comprising: a grid framework (14) structure comprising: a first set of parallel members (22a) and a second set of parallel members (22b) extending substantially perpendicularly to the first set of members (22b) in a substantially horizontal plane to form a grid pattern comprising a plurality of grid spaces, wherein the grid is supported by a set of uprights (16) to form a plurality of vertical storage locations beneath the grid for containers (10) to be stacked between and be guided by the uprights in a vertical direction through the plurality of grid spaces, at least one load handling device as discussed above operating on the grid framework structure wherein the at least one load handling device further comprises a communication means; and a centralised control utility for controlling the at least one load handling device(s) to: lift a container from a stack beneath the grid, AND OR lower a container into a stack beneath the grid.

It will be appreciated that the gripper may be used as part of a lifting assembly mounted on a load handling device. The load handling device may be suitable for moving on a grid-based framework, where parallel members of the grid may comprise parallel tracks or rails. The load handling device may be directed to carry out a series of lifting and transporting operations on containers, using one or more grippers and one or more actuation movements to latch to the containers. It will be appreciated that an improved gripper may lead to improvements in the operation of load handling devices, and accordingly improvements in a storage and retrieval system.

For example, the gripper arms may be inserted though and opening in a container edge when in a closed position, and then opened using the actuation means. In the open position, the gripper is arranged to be too wide to be removed from the opening, thereby latching the gripper to the container. The actuation means may also lock the gripper arms in position to prevent accidental movement of the gripper arms between open and closed positions, and be confident that the gripper will remain secured to the container.

It will be appreciated that the gripper may be used together with any suitable equipment or devices, and use of the gripper is not limited to the examples given in connection with a load handling device operating on a grid-based storage picking and retrieval system described herein.

Other aspects and advantages will become apparent from the following description.

### DETAILED DESCRIPTION

The invention will now be described with reference to the accompanying diagrammatic drawings in which:

FIG. 1 is a schematic, perspective view of a frame structure for housing a plurality of stacks of bins in a storage system;

FIG. 2 is a schematic, plan view of part of the frame structure of FIG. 1;

FIGS. 3(a) and 3(b) are schematic, perspective views, from the rear and front respectively, of one form of robotic load handling device for use with the frame structure of FIGS. 1 and 2, and FIG. 3(c) is a schematic perspective view of the known load handler device in use lifting a bin;

FIG. 4 is a schematic, perspective view of a known storage system comprising a plurality of load handler devices of the type shown in FIGS. 3(a), 3(b) and 3(c), installed on the frame structure of FIGS. 1 and 2;

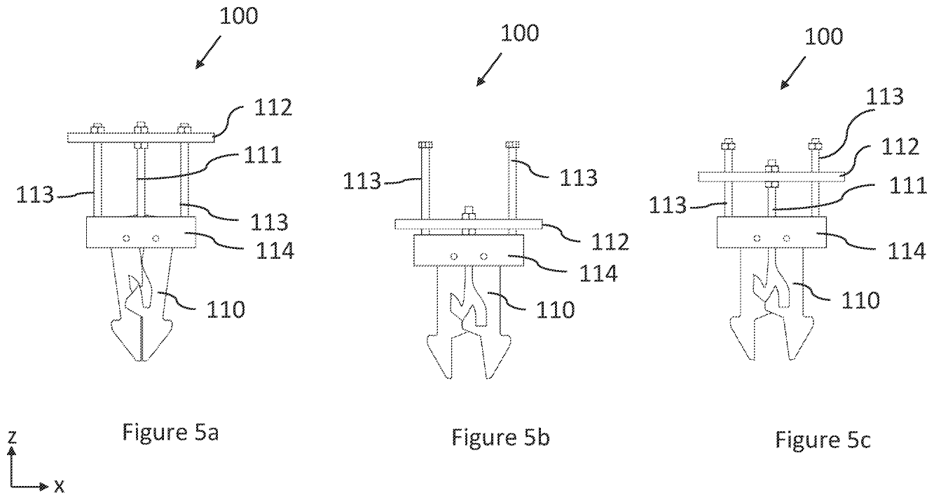

FIGS. 5a-c show schematic z-x plane or front views of a gripper, which may be for use on a gripper assembly of a load handling device for lifting container(s) when operating within a system as described above in connection with FIGS. 1-4.

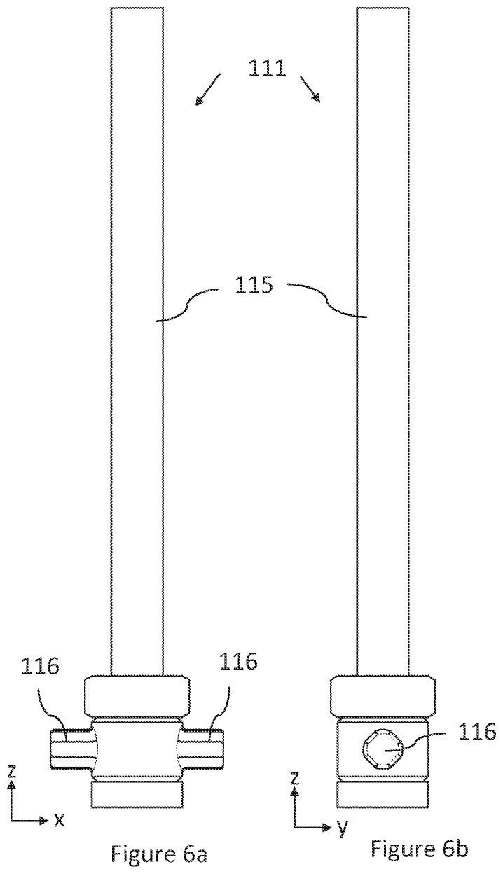

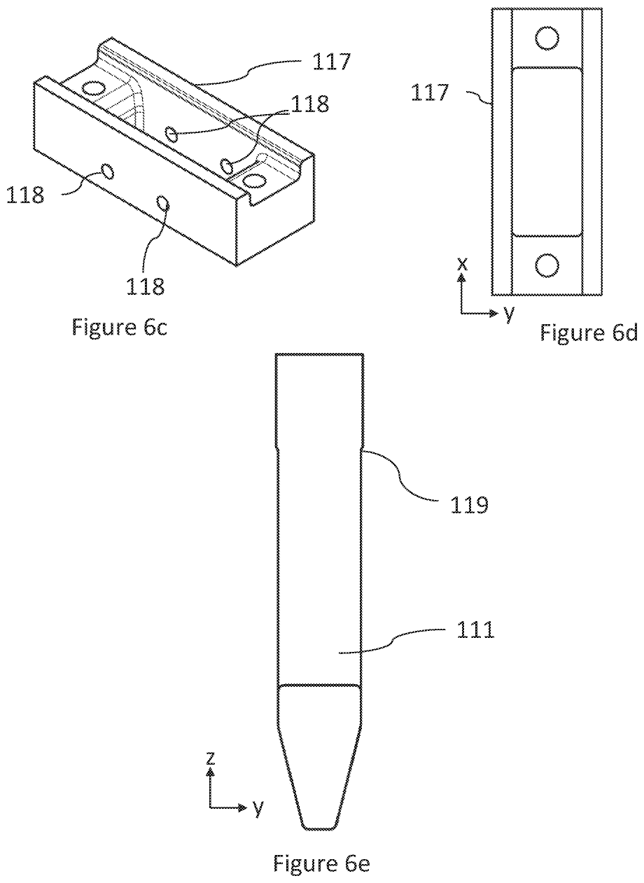

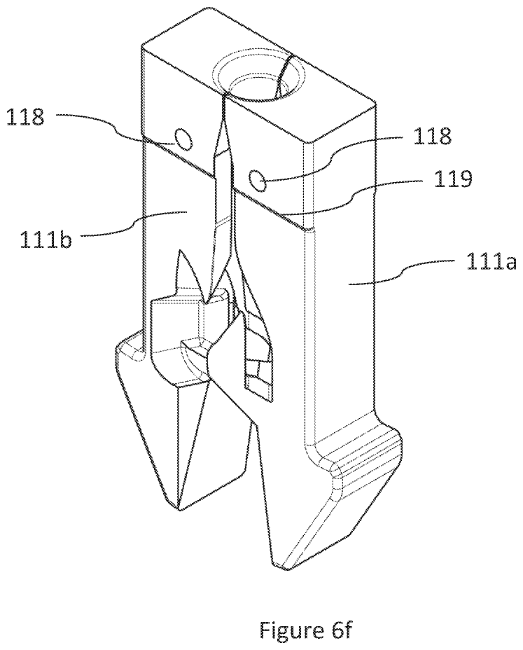

FIGS. 6a, 6b, 6c, 6d, 6e and 6f are a schematic views of the components which makeup the gripper;

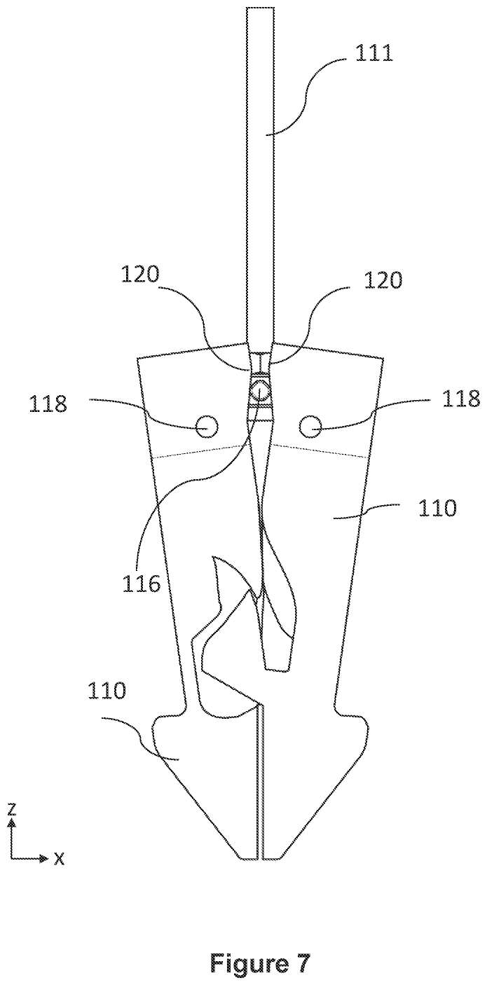

FIG. 7 is a schematic view of a pair of gripper arms with a plunger positioned between the arms;

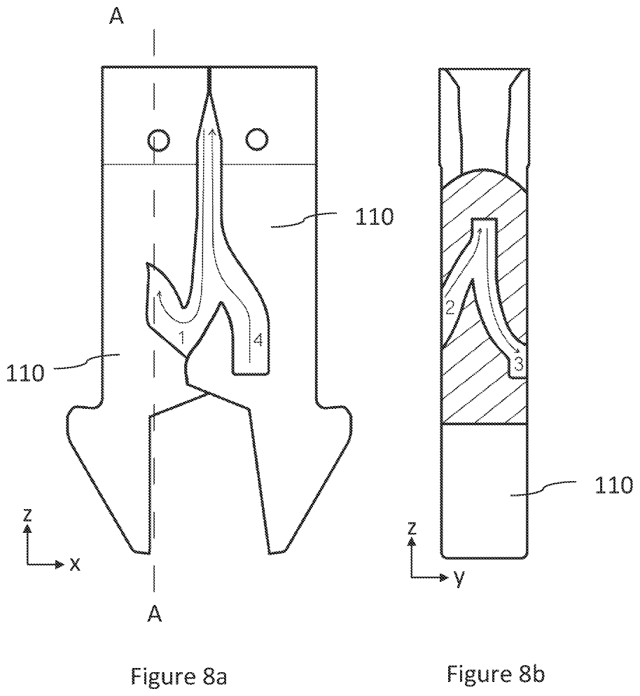

FIGS. 8a and 8b are schematic views of a gripper for use as part of a gripper assembly, FIG. 8a shows a front view of a pair of cooperating gripper arms, and FIG. 8b shows a section view along the line A-A indicated in FIG. 8a showing internal channels within one of the gripper arms;

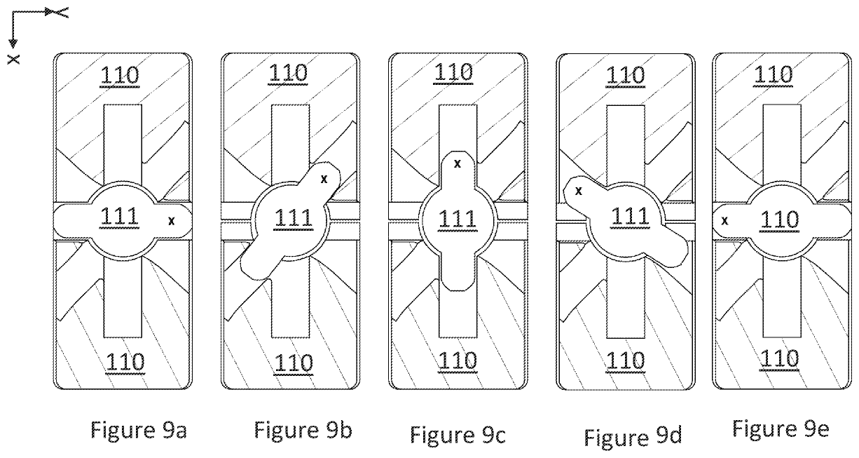

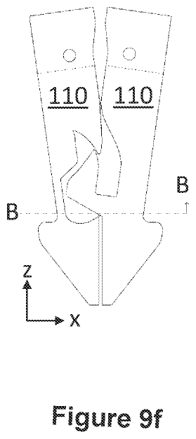

FIGS. 9a, 9b, 9c, 9d, and 9e are schematic views of the gripper taken through the line B-B as indicted in FIG. 9f, showing the sequence of positions of the plunger as the moves through the internal channels of the gripper;

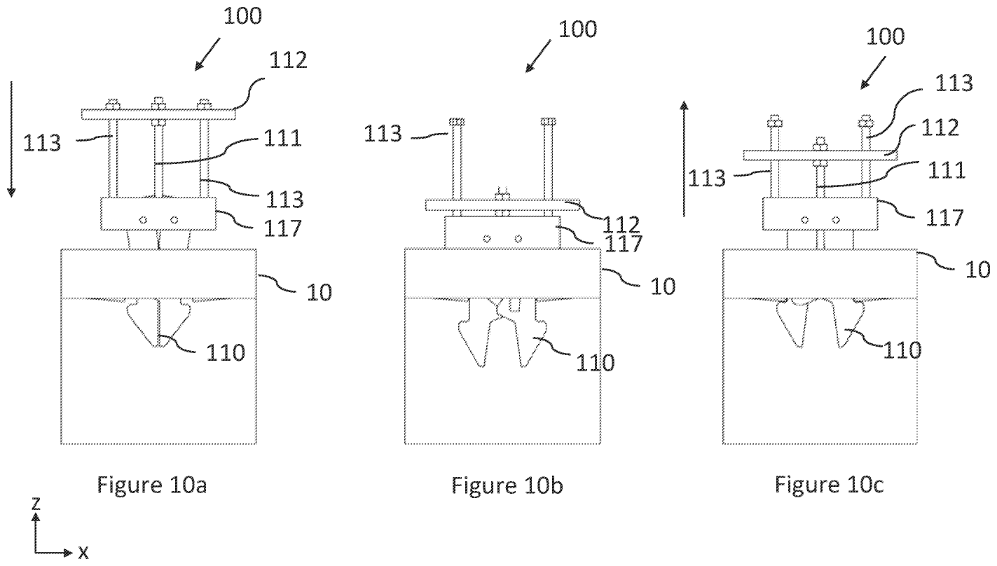

FIGS. 10a, 10b and 10c are schematic views of the gripper in use for lifting a container;

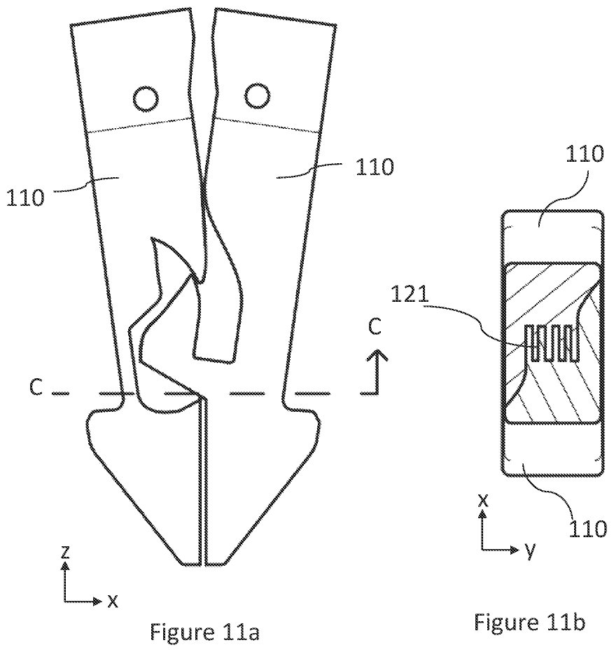

FIGS. 11a and 11b are schematic views of a pair of gripper arms, having meshing teeth;

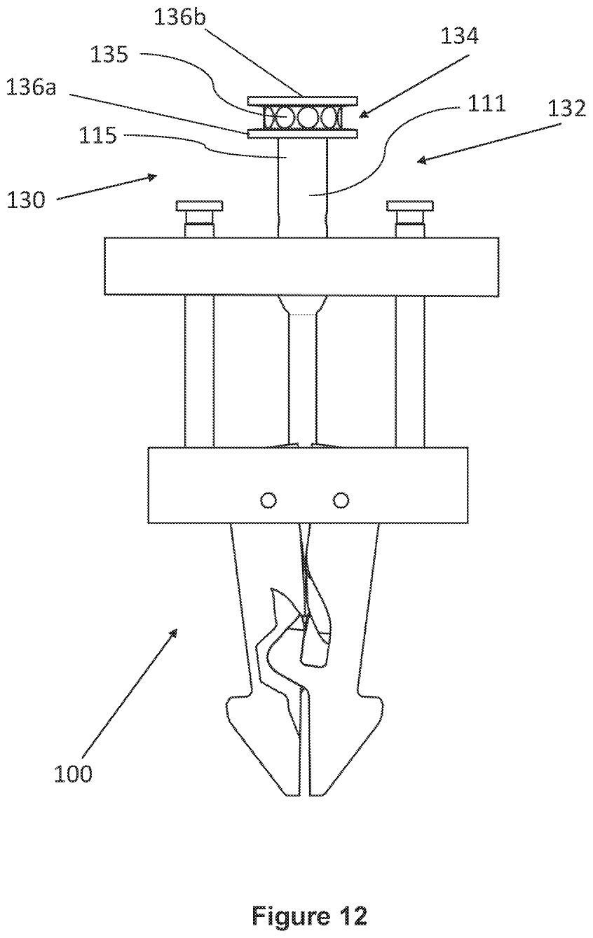

FIG. 12 is a schematic view of the gripper comprising a gripper attachment;

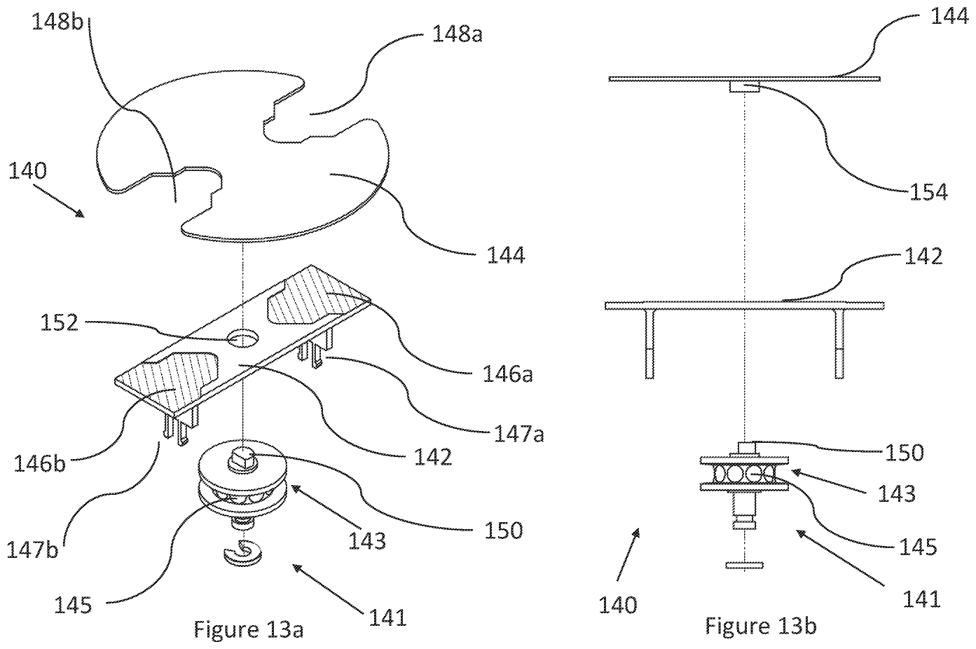

FIGS. 13a and 13b show exploded views of an indicator, where FIG. 13a is a perspective view and FIG. 13b is a front view;

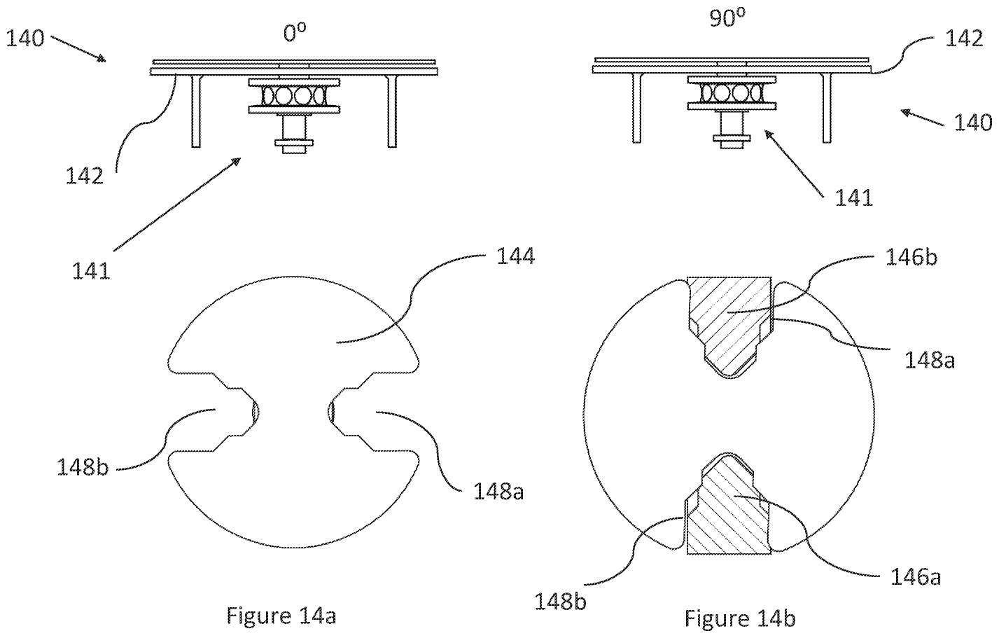

FIGS. 14a and 14b each show front and top views of the indicator at 0° rotation (FIG. 14a) and at 90° rotation (FIG. 14b); and

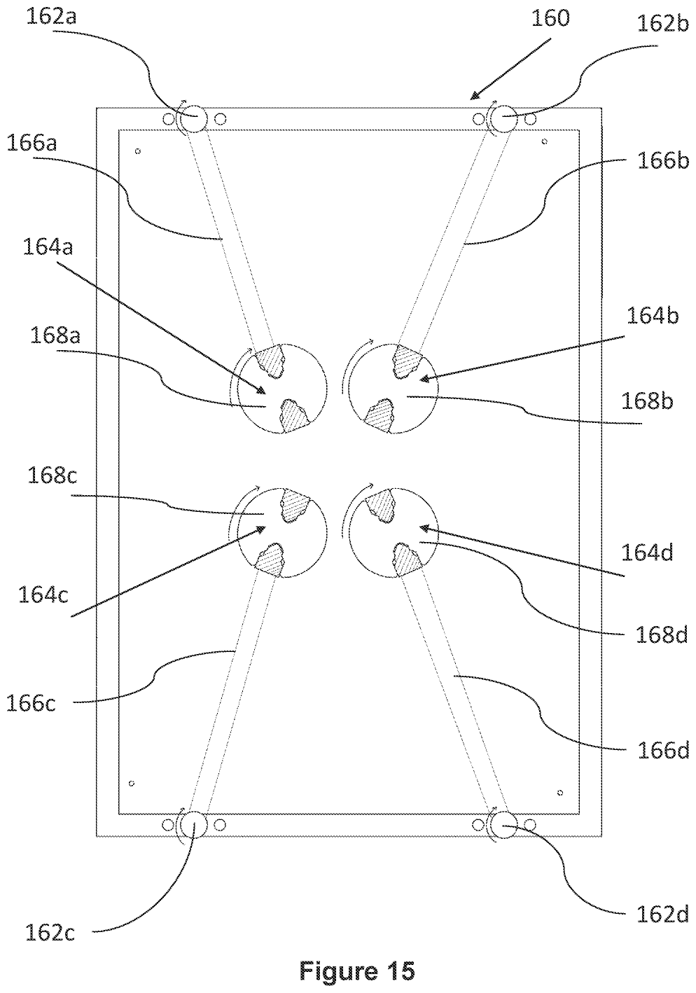

FIG. 15 shows a top view of a lifting assembly comprising four grippers each comprising an indicator.

It is known that a cam is a rotating piece in a mechanical linkage used to transform rotary motion into linear motion. Typically a shaft with an irregular cylindrical shape may produce a smooth reciprocating motion of a leaver in contact with the cam. A linear cam is one in which the cam element moves along a line, rather than rotating. The claim profile is cut into an edge or face of a plate or block. The gripper described herein is a cam variant.

The gripper 100 comprises a pair of gripper arms 110 operated by a plunger 111. The plunger 111 is held between the gripper arms 110 and is guided by a frame. The frame comprises two posts 113, on which a plate 112 may slide, wherein the plate 112 slides with the plunger 111. Vertical motion of the plunger 111 causes the gripper arms 110 to open and close. Further the plunger 111 may be used to lock the gripper 100 in position. In FIG. 5a, the plunger 111 fully raised and the gripper arms 110 are closed. In FIG. 5b, the plunger 111 is fully depressed and the gripper arms 110 are open. In FIG. 5c, the plunger 111 is at a half-way point or height and the gripper arms 110 are locked open. The vertical motion of the plunger 111 and the effect of the motion on the gripper 100 is described in more detail below.

FIG. 6 shows schematic views of each of the components which fit together to make the gripper 110. FIGS. 6a and 6b show the plunger 111, for use as an actuator means, shown as z-x and z-y views respectively. The plunger 111 comprises a rod 115 and a pair of symmetrically arranged radial pins 116 at one end, referred to as the distal end herein. As may be seen in FIG. 6b, the pins 116 are substantially octagonal in cross section.

FIG. 6c is a schematic perspective view and FIG. 6d is a schematic x-y view of the gripper housing 117, and FIG. 6e is a schematic z-y view of a gripper arm. A pair of cooperating gripper arms 110 are held together in the housing 117. Holes 118 are used to pivotally attach the arms 110 to the housing 117, keeping the pair of arms 110 in place within the housing 117. As can be seen in FIG. 6c, the inner side of the housing ends is curved to allow the gripper arms 110 to rotate about the pivot point 118. As can be seen in FIG. 6e, the head of the gripper arms 110 has a lip 119 which interacts with a corresponding lip around the lower inside edge of the housing 117 (not shown) to prevent the gripper arms 110 from falling through the housing 117. As described herein, the head end of the gripper arms is at the upper most end of the gripper 110 when in use, and the distal end is the lower most end of the gripper 110 when in use. When assembled, the gripper arms 110 rotate about the pivots 118 between the closed and open positions. FIG. 6f is a perspective view of a pair of gripper arms 110a, 110b. The gripper arms 110a, 110b are each the same, having 180° rotational symmetry. The inside face of the gripper arms 110a, 110b have recesses and cooperating protrusions, shaped to fit together when two gripper arms 110a, 110b are arranged side-by-side and the gripper is closed. The inside surface of the gripper arms 110a, 110b further comprise a number of cam grooves or channels which will be discussed in more detail below.

FIG. 7 shows a schematic z-x plane view of the pair of cooperating gripper arms 110 in a closed position, with the actuator means or plunger 111 inserted in the top of the pair 110. For simplicity the gripper housing is not shown in FIG. 7. In this position, the plunger pins 116 are orientated transverse to the gripper arms 110, or aligned with the gap between the gripper arms 110, and the gripper arm protrusions are nested within the cooperating recess.

FIG. 8a shows a schematic views of a pair of cooperating gripper arms 110, and FIG. 8b shows a section view along the line A-A indicated in FIG. 8a. For simplicity the gripper housing is not shown in FIG. 8. In such an arrangement, the recesses of the gripper arms form channels 1, 2, 3, 4 for receiving the distal end of the plunger (not shown). The channels define four distinct pathways that the plunger 111 follows in sequence -1-2-3-4-1- . . . etc. when actuated. As the plunger end moves vertically through the channels 1-4, the plunger 111 is guided on the sequenced pathway by the plunger pins 116 directed by the cam surfaces of the gripper arms 110. As noted above, the cross section of the pins 116 is octagonal. The pin edges may be bevelled also. This assists in smooth movement of the distal end of the plunger 111, and with keeping the pins 116 aligned with the channels 1-4. The shape of the cam surfaces causes the plunger 111 to rotate as the plunger 111 moves vertically.

FIGS. 9a-e are a schematic view of the taken through the pair of gripper arms 110 (as indicated along the B-B in FIG. 9f) showing the orientation of the plunger pins 116 as the plunger 111 moves through the channels 1-4. One pin 116 is marked with an ‘x’ to aid understanding of the relative rotation of the plunger 111 as it moves vertically through the channels 1-4. In practice the upper surface of the plunder 111 may be marked with an indicator means so that the orientation of the plunger 111 (and gripper arms) may be determined from above or distally from the gripper itself. FIGS. 10a-c are schematic views of the gripper 100 in use to lift a container 10. It will be appreciated that FIGS. 10a-c are similar to FIGS. 5a-c, with the addition of a container 10.

With the tips of the hook ends together in a closed position (FIG. 7), the distal end of the plunger 111 is located substantially at the top of the gripper 100, between the two gripper arms 110 and with the pins 116 aligned with the gap between the gripper arms 110 (FIG. 9a). In this arrangement of the gripper 100 the distal end of the gripper 100 may be inserted through an opening in a container 10 as shown in FIG. 10a and indicated by the arrow.

The downward movement may be continued into a first actuation movement of the gripper 100 where the plunger 111 is pushed in a substantially vertical downward direction relative to the gripper arms. The distal end of the plunger 111 follows the channel pathway 1 (FIG. 8a), and the gripper housing 117 and plate 112 abut the upper edge of the container 10. As the plunger end moves downward along channel 1, the rod 115 is caused by the pins 116 moving along the cam surface to rotate in a clockwise direction by approximately 45° (FIG. 9b). At the same time, the gripper arms 110 are pushed apart by the rod 115 moving down the channel between the upper part or head of the gripper arms 110 resulting in the gripper 100 moving to the open position (FIG. 10b).

To position the gripper 100 in place to lift the container 10, in the open position, the gripper 100 is lifted in an upward direction so that the hook ends abut and engage with the inside edge surrounding the container opening (FIG. 10c). In the same motion a second substantially vertical actuation movement of the plunger 111 relative to the gripper arms 110 pulls the plunger upwards rod end is directed along channel 2 to an upper position within the gripper arms 110. Moving along channel 2 the rod 115 is caused to rotate in a clockwise direction by approximately 45° and the pins 116 become aligned transverse to the gap between the gripper arms 110 (FIG. 9c). The rod end is now located in the uppermost position within the channel 2. The transverse pin 116 alignment at the top of channel 2 locks the gripper 110 in the open position. Accordingly in this position, the gripper 100 is secured in the container 10 and cannot be pulled out of the container opening.

To release the gripper 100, the gripper 100 must be returned to a closed position. In a third actuation movement, the plunger 111 is pushed downward relative to the gripper arms and the rod end is directed along channel 3. The shape of the channel causes the rod to rotate in a clockwise direction by approximately 45° (FIG. 9d). At the same time, the gripper arms 110 disengage with the underside of the container top edge, and the gripper housing 117 is pushed against the outside of the container.

Finally, in a fourth actuation movement, the plunger 111 is pulled in an upward direction along channel 4 to the return to the starting position. The shape of the channel causes the rod 115 to rotate in a clockwise direction by approximately 45°, where the pins 116 are again aligned with the gap between the gripper arms (FIG. 9e) and at the top of the gripper arms (FIG. 7). At the same time, the gripper arms 110 move together into the closed position under gravity (i.e. under the weight of the gripper arms 110) as the plunger is pulled upward and out from between the gripper arms 110. Alternatively, the gripper arms 110 can be forced together into the closed position as the plunger 111 moves upward. As can be seen in FIG. 7 just above the pivot points 118, the sides of the arms 110 are angled to the pinch point 120 to force the gripper arms 110 into the closed position when the plunger end is raised. The gripper 100 can then be removed from the container by continuing the upward movement and lifting the gripper out of the opening.

It will be appreciated from comparing FIGS. 9a and 9e that the plunger 111 has rotated by 180° from the closed start position, though the open and locked positions and back to a closed position. It will be appreciated from viewing FIGS. 10a-10c together, the vertical displacement of the plunger 111 relative to the gripper housing 117 has three positions: fully raised (FIG. 7 and FIG. 10a); fully depressed (FIG. 10b); and a half-way position between fully raised and fully depressed (FIG. 10c) where the plunger end is at the top of the channel 2. Not show, detent means may be used to ensure that the plunger ratchets between positions shown in FIGS. 9a-9e. Further, detent means may assist vertical movement of the plunger to move from one position to the next.

In order to retain the plunger 111, at the head end, the opening between the gripper arms is shaped with a pinch point 120, shown in FIG. 7. At the pinch point 120, the channel is too narrow for the plunger end and pins 116 to pass through. Therefore, when the gripper 100 is held together in the housing 117 it is not possible to accidentally remove the plunger 111.

FIG. 11 shows a feature where the arms 110 are shaped to have meshing teeth 121. FIG. 11a shows a schematic z-x plane view, and FIG. 11b shows a section view though the line C-C indicated on FIG. 11a. The teeth XX interlock or mesh together when the arms are in the closed position. This feature helps to maintain alignment of the gripper arms 111, and additionally locks the arms together.

FIG. 12 shows the gripper 100 including a gripper attachment 130 for connecting the gripper 100 to an indicator 140 (shown in FIGS. 13-15 and described further below). The gripper attachment 130 is connected to the top or proximal end 132 of the plunger 111 and is connected such that rotation of the plunger 111 causes rotation of the gripper attachment 130. The gripper attachment 130 includes a ball chain receiving portion 134 for receiving a ball chain (not shown). The ball chain receiving portion 134 encircles the rod 115 of the plunger 111 and includes a plurality of hemispherical concave recesses or sockets 135, each socket 135 being able to receive a ball from the ball chain. The ball chain receiving portion 134 is disposed between two parallel plates 136a, 136b that are transverse to the axis of the ball chain receiving portion 134 and the plunger 111 so that they act as washers for the ball chain received in the ball chain receiving portion 134.

FIG. 13a shows an exploded perspective view of the components forming the indicator 140, and FIG. 13b shows an exploded front view of the components forming the indicator 140. The indicator 140 includes an indicator attachment 141, an elongate indicating plate 142 and a cover plate 144 disposed over the indicating plate 142. The indicator attachment 141 includes a ball chain receiving portion 143 for receiving the ball chain (not shown). The ball chain receiving portion 143 includes a plurality of hemispherical concave recesses or sockets 145 of same shape and size as the sockets 135 in the ball chain receiving portion 134 of the gripper attachment 130 (shown in FIG. 12). This allows the same ball chain received in the ball chain receiving portion 134 of the gripper attachment 130 to be received in the ball chain receiving portion 143 of the indicator attachment 141. The ball chain loops around the ball chain receiving portions 134 and 143 and mechanically connects the plunger 111 with the indicator 140 (see FIG. 15). The ball chain receiving portions 134 and 143 act as pulleys or sprockets for the ball chain, where the ball chain receiving portions can drive the ball chain as they rotate or be driven by the rotating ball chain. In particular, as the gripper attachment 130 rotates (as a result of the plunger 111 rotating) it drives the ball chain disposed in the ball chain receiving portion 134. In turn, the driven ball chain causes rotation of the indicator attachment 141. The ball chain ensures synchronised and equal rotation between the gripper attachment 130 and the indicator attachment 141. The action of the ball chain is described in further detail below in relation to FIG. 15.

The indicating plate 142 includes coloured or contrast regions 146a, 146b on its top surface at each longitudinal end of the indicating plate 142. The indicating plate 142 also includes two downwardly extending clips 147a, 147b for attaching the indicating plate 142 to a lifting assembly. The clips 147a, 147b advantageously allow for easy attachment and/or removal of the indicating plate 142 from the lifting assembly. This enables the indicating plate 142 to be retrofitted to the lifting assembly, aiding manufacturing and assembly of the lifting assembly.

The cover plate 144 has a substantially circular shape and includes two cut-outs 148a, 148b which match the shape of the contrast regions 146a, 146b on the indicating plate 142, such that the contrast regions 146a, 146b on the indicating plate 142 are visible from above when the cut-outs 148a, 148b are aligned with the contrast regions 146a, 146b.

The cover plate 144 and the indicating plate 142 fit onto the indicator attachment 141. In particular, the indicator attachment 141 includes a central bolt head 150 which passes through a central locating hole 152 in the indicating plate 142 and fits into a projection 154 on the underside face of the cover plate 144. The projection 154 includes a hole or recess (not shown) for receiving the bolt head 150. The hole or recess has a semi-circular cross-section of same size as the semi-circular cross-section of the bolt head 150. This semi-circular cross section ensures that rotation of the bolt head 150 results in synchronised rotation of the cover plate 144.

The locating hole 152 in the indicating plate 142 allows for free rotation of the bolt head 150 relative to the indicating plate 142. Thus, the indicating plate 142 does not rotate with the indicator attachment 141. Furthermore, the clips 147a, 147b on the indicating plate 142 secure the indicating plate 142 to the lifting assembly, thereby further ensuring that the indicating plate 142 does not rotate with the indicator attachment 141. Thus, the cover plate 144 rotates with the indicator attachment 141 and relative to the indicating plate 142.

In the above embodiment, the cross section of the bolt head 150 ensures synchronised rotation between the bolt head 150 (and thus the indicator attached 141) and the cover plate 144. However, the skilled person will know of numerous other connecting means between the indicator attachment 141 and the cover plate 144 that result in equal or synchronized rotation between these two elements.

FIG. 14a shows front and top views of the indicator 140 when the plunger 111 is at a 0° rotation, and FIG. 14b shows front and top views of the indicator 140 when the plunger is at a 90° rotation.

As described above, the gripper arms 110 start from the closed start position (shown in FIG. 9a), move to the open and locked position (shown in FIG. 9c) before moving to the closed end position (shown in FIG. 9e). When the gripper arms 110 are in the closed start position, the plunger 111 is at a 0° rotation and the cover plate is positioned with the cut-outs 148a, 148b in the cover plate not aligned over the contrast regions 146a, 146b on the indicating plate 142, i.e. the cover plate covers the contrast regions and the contrast regions are not visible. As the gripper arms 110 move from the closed start position to the open and locked position, the plunger 111 rotates by 90°. As noted above, rotation of the plunger 111 causes rotation of the gripper attachment 130 which drives the ball chain disposed in the ball chain receiving portions 134, 143. In turn, the ball chain drives the indicator attachment 141 causing the cover plate 144 to rotate. The ball chain ensures synchronised and equal rotation between the gripper attachment 130 and the indicator attachment 141. Thus, as the plunger 111 rotates by 90°, this causes the indicator attachment 141 and the cover plate 144 to rotate by 90°. Rotating the cover plate 144 by 90° positions the cut-outs 148a, 148b over the contrast regions 146a, 146b on the indicating plate (i.e. the cut-outs 148a, 148b are aligned over the contrast regions 146a, 146b), such that the contrast regions 146a, 146b are exposed and visible from above.

As the gripper arms 110 move from the open and locked position to the closed end position, the plunger 111 and gripper attachment 130 rotate again by 90°, causing the indicator attachment 141 and the cover plate to rotate by 90° so that the cut-outs 148a, 148b are no longer aligned over the contrast regions 146a, 146b, i.e. the cover plate covers the contrast regions and the contrast regions are not visible. As the gripper arms 110 move between the closed and open and locked positions, the cover plate rotates by 90° thereby covering or exposing the contrast regions 146a, 146b.

Thus, the indicator 140 provides a visual means for a technician, an operator, a camera etc. to determine the status of the gripper arms 110 (i.e. whether the gripper arms are closed or open) and therefore whether the gripper 100 is latched to a storage container 10.

Rotating the cover plate by 90° so as to cover or expose the contrast regions 146a, 146b provides a binary indication of whether the gripper arms 110 are in the start/end closed positions or the open and locked position, i.e. the indicator 140 provides a binary indication of whether the gripper arms 110 are ‘closed’ or ‘open’. This provides a straightforward visual assessment for an operator, technician or camera when determining whether the gripper arms 110 are in the closed positions or the open position. This binary indication is also particularly useful when the assessment is used for machine learning purposes.

FIG. 15 shows a top view of a lifting assembly 160 comprising four grippers each with a gripper attachment 162a, 162b, 162c, 162d. The gripper attachments 162a, 162b, 162c, 162d are each connected to a respective indicator 164a, 164b, 164c, 164d by a ball chain 166a, 166b, 166c, 166d. The gripper attachments 162a, 162b, 162c, 162d and the indicators 164a, 164b, 164c, 164d are as described above. Each ball chain 166a, 166b, 166c, 166d loops around the ball chain receiving portion of the gripper attachment and the ball chain receiving portion of the indicator attachment and mechanically connects the plungers with the indicators 164a, 164b, 164c, 164d. As described above, the ball chain receiving portions act as pulleys or sprockets for the ball chains 166a, 166b, 166c, 166d. As the gripper attachments 162a, 162b, 162c, 162d rotate (as a result of the plungers rotating) they drive the ball chains 166a, 166b, 166c, 166d. In turn, the driven ball chains cause rotation of the indicator attachments. The ball chains ensure synchronised and equal rotation between each gripper attachment 162a, 162b, 162c, 162d and their indicator attachment.

Each indicator 164a, 164b, 164c, 164d includes a cover plate 168a, 168b, 168c, 168d that rotates by 90° (as shown by the arrows) to cover or expose the contrast regions, thereby indicating whether the respective gripper arms of each gripper are in the opened or closed positions. By providing an indicator 164a, 164b, 164c, 164d for each gripper in the lifting assembly 160, it can be determined whether the individual grippers are in or out of phase with one another, i.e. whether all four grippers have their gripper arms in the closed position or in the open position. Furthermore, by providing an indicator for each gripper as shown in FIG. 15, multiple indicators can be viewed simultaneously, thereby providing a straightforward means for a technician/operator or camera to determine whether the grippers are in phase and in sync with each other. Having all grippers in a lifting assembly in sync with each other is particularly advantageous for ensuring effective and optimal functioning of the lifting assembly. The grippers are located on the periphery of the lifting assembly 160 whereas the indicators 164a, 164b, 164c, 164d are provided within the periphery of the lifting assembly 160, in particular towards the centre of the lifting assembly 160. This advantageously allows a viewer or a camera with a relatively narrow field of vision to view all the indicators 164a, 164b, 164c, 164d simultaneously.

It will be appreciated that variations to the shape of the gripper which result in the descried functionality are intended to be within the scope of this disclosure. Machine learning ML techniques may be utilities to improve on the form function of the gripper, and optimise characteristics of the gripper.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

It will be appreciated that a farming system, method and devices can be designed for a particular application using various combinations of devices and arrangements described above. It will be appreciated that the features described hereinabove may all be used together in a single system. In other embodiments of the invention, some of the features may be omitted. The features may be used in any compatible arrangement. Many variations and modifications not explicitly described above are possible without departing from the scope of the invention as defined in the appended claims.

In this document, the language “movement relative to a gap” is intended to include movement within the gap, e.g. sliding along the gap, as well as movement into or out of a gap.

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis).

In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else.

1. A gripper for latching to a storage container, comprising:
a gripper housing;
a pair of gripper arms held in the gripper housing, wherein the gripper arms have cooperating shapes; and
a movable rotatable actuator means held in a channel between the pair of gripper arms for moving the gripper arms between closed and open positions;
wherein the gripper is configured to be actuated with a substantially vertical or z-axis movement of the actuator means.

2. A gripper according to claim 1, wherein an inner surface of each of the gripper arms comprise;
a cam surface having a number of grooves or channels for receiving a distal end of the actuator means.

3. A gripper according to claim 2, wherein the cam surface is at least partially curved or spiralled.

4. A gripper according to claim 2, wherein each of the channels spiral in a same rotational direction.

5. A gripper according to claim 2, wherein the pair of gripper arms comprise:
four substantially enclosed channels for receiving the distal end of the actuator means.

6. A gripper according to claim 1, wherein each of the pair of gripper arms are substantially the same.

7. A gripper according to claim 1, wherein each of the pair of gripper arms have 180° rotational symmetry about a z-axis.

8. A gripper according to claim 1, comprising:
indicating means for rotational position of the actuator means.

9. A gripper according to claim 1, comprising:
a detent means for orientating the actuator means.

10. A gripper according to claim 1, wherein the actuator means comprises:
a plunger having at least one radial pin located at a distal end for guiding rotational movement of the plunger.

11. A gripper according to claim 10, wherein each plunger radial pin has a substantially octagonal cross section.

12. A gripper according to claim 1, wherein the gripper is configured such that the actuator means will provide at least one or more of:
a first actuation movement to cause the gripper arms to move from the closed position to the open position,
a second actuation movement to lock the gripper arms in the open position,
a third actuation movement to unlock the gripper arms, and/or
a fourth actuation movement to cause the gripper arms to move from the open position to the closed position.

13. A gripper according to claim 1, wherein the channel between the pair of gripper arms is angled to make a pinch point.

14. A gripper according to claim 1, wherein each of the gripper arms comprises:
a number of meshing teeth.

15. A gripper according to claim 1, wherein a distal end of each of the gripper arms comprises:
a hook for latching to a storage container, and/or wherein the distal end of the gripper arms are tapered.

16. A gripper according to claim 1, comprising:
an indicating means for indicating whether the gripper arms are in the closed position or the open position.

17. A gripper according to claim 16, wherein the indicating means comprises:
an indicating plate and a cover plate disposed over the indicating plate, the indicating plate including at least one differentiating region on its top surface, and the cover plate including at least one cut-out that is alignable over the differentiating region on the indicating plate.

18. A gripper according to claim 17, wherein the indicating means is connected to the actuator means such a that rotation of the actuator means will produce synchronised rotation of the cover plate.

19. A gripper according to claim 17, wherein the actuator means is rotatable to position the cover plate in a first position where the at least one cut-out is not aligned over the at least one differentiating region.

20. A gripper according to claim 19, wherein the actuator means is rotatable to position the cover plate in a second position where the at least one cut-out is aligned over the at least one differentiating region.

21. A gripper according to claim 16, wherein the indicating means is laterally displaced from the gripper.

22. A load handling device in combination with at least one gripper according to claim 1, the load handling device being configured for lifting and moving storage containers stacked in a grid framework structure which includes first set of parallel members and a second set of parallel members extending substantially perpendicularly to the first set of members in a substantially horizontal plane to form a grid pattern having a plurality of grid spaces, wherein the grid is supported by a set of uprights to form a plurality of vertical storage locations beneath the grid for containers to be stacked between and be guided by the uprights in a vertical direction through the plurality of grid space, the load handling device comprising:
a body mounted on a first set of wheels configured and arranged to engage with the first set of parallel members and a second set of wheels configured and arranged to engage with the second set of parallel members; and
a lifting assembly for raising and or lowering a load, the lifting assembly including the one gripper.

23. A load handling device according to claim 22, wherein the at least one gripper of the lifting assembly comprises:
an indicating means for indicating whether the gripper arms are in the closed position or the open position.

24. A load handling device according to claim 23, comprising:
a detection means for detecting a status of the indicating means, the status of the indicating means being based on whether the gripper arms are in the closed position or the open position.

25. A load handling device according to claim 24, wherein the detection means is located at a distance from the indicating means.

26. A method of gripping with one or more grippers, each gripper having a gripper housing, a pair of gripper arms held in the gripper housing wherein the gripper arms have cooperating shapes, and a movable rotatable actuator means held in a channel between the pair of gripper arms for moving the gripper arms between closed and open positions, wherein the gripper is configured to be actuated with a substantially vertical or z-axis movement of the actuator means, the method, comprising:
actuating the one or more grippers with a first actuation movement to cause the gripper arms to move from a closed position to a open position;
actuating the one or more grippers with a second actuation movement to lock the gripper arms in the open position;
actuating the one or more grippers with a third actuation movement to unlock the gripper arms; and/or
actuating the one or more grippers with a fourth actuation movement to cause the gripper arms to move from the open position to the closed position.

27. A grid-based storage and retrieval system comprising:
a grid framework structure including:
a first set of parallel members and a second set of parallel members extending substantially perpendicularly to the first set of members in a substantially horizontal plane to form a grid pattern having a plurality of grid spaces, wherein the grid is supported by a set of uprights to form a plurality of vertical storage locations beneath the grid for containers to be stacked between and be guided by the uprights in a vertical direction through the plurality of grid spaces;
at least one load handling device configured for operating on the grid framework structure wherein the at least one load handling device includes: a gripper having a gripper housing; a pair of gripper arms held in the gripper housing, wherein the gripper arms have cooperating shapes; and a movable rotatable actuator means held in a channel between the pair of gripper arms for moving the gripper arms between closed and open positions; wherein the gripper is configured to be actuated with a substantially vertical or z-axis movement of the actuator means, and the handling devices includes a communication means; and
a centralised control utility for controlling the at least one load handling device(s) to: lift a container from a stack beneath the grid, and/or lower a container into a stack beneath the grid.
